(19) United States
(12) Patent Application Publication
(10) Pub. No.: US 2015/0143378 A1
(43) Pub. Date: May 21, 2015

(54) MULTI-THREAD PROCESSING APPARATUS AND METHOD FOR SEQUENTIALLY PROCESSING THREADS

(71) Applicant: Samsung Electronics Co., Ltd., Suwon-si (KR)

(72) Inventors: Sang-heon LEE, Hwaseong-si (KR); Soo-jung RYU, Hwaseong-si (KR); Yeon-gon CHO, Hwaseong-si (KR)

(73) Assignee: Samsung Electronics Co., Ltd., Suwon-si (KR)

(21) Appl. No.: 14/261,649

(22) Filed: Apr. 25, 2014

(30) Foreign Application Priority Data
Nov. 15, 2013 (KR) 10-2013-0139322

(51) Int. Cl. G06F 9/48; G06F 9/50

(52) U.S. Cl. CPC G06F 9/4843; G06F 9/4881; G06F 9/5027
USPC 718/103; 718/102; 718/104

(57) ABSTRACT

Provided are a multi-thread processing apparatus and method for sequentially processing threads. The multi-thread processing method includes scheduling, at a processor, one of a plurality of thread groups allocated by a job distributor, determining whether the thread group has been initialized based on an examination an uninitialized flag of the scheduled thread group, generating a thread group descriptor for the scheduled thread group and initializing the thread group based on the determination of whether the thread group has been initialized, and initializing a thread descriptor based on a determination of whether initialization is needed and sequentially executing each thread in the scheduled thread group.

### RELATED APPLICATIONS

This application claims the benefit under 35 USC 119(a) of Korean Patent Application No. 10-2013-0139322, filed on Nov. 15, 2013, in the Korean Intellectual Property Office, the entire disclosure of which is incorporated herein by reference for all purposes.

### BACKGROUND

1. Field

The following description relates to multi-thread processing methods and apparatuses for sequentially processing threads in a thread group.

2. Description of Related Art

As technology has rapidly advanced and general-use computers such as servers have been recognized as a part of social infrastructure, there has been an increase in the demand for improvement of performance of a computer or power saving operation. Such a demand for improved performance and efficiency may also apply to a central processing unit (CPU) within a computer.

One means of meeting the demand is to configure a CPU to include a plurality of cores, or to apply techniques for processing a plurality of instruction threads within a single core. One technique for processing a plurality of instruction threads is a multi-thread method.

Multi-threading refers to a multitasking processing mode within one application program that creates a plurality of execution units called threads for concurrent execution. Like multitasking, the multi-threading includes dividing the amount of time for which a CPU is dedicated to a process into small units of time, sequentially allocating the units of time to a plurality of threads, thereby enabling simultaneous execution of the plurality of threads.

A thread refers to a sequence of jobs or a flow of program required to complete execution of a single instruction. Thread processing is classified into single-thread processing and multi-thread processing. Single-thread processing allows all programs or jobs to be completed before starting execution of a new instruction. Multi-thread processing allows a thread for one instruction to be processed while a thread of another instruction is suspended before completing its execution. Thus, achieving concurrent and parallel execution of a plurality of threads.

A Graphics Processing Unit (GPU) is a device for efficiently performing the same program code for a large amount of input data and has a large number of parallel processing units integrated within the GPU to provide high computational power. Due to its high computational power, a GPU is increasingly becoming more important and is being widely used in arithmetic operations in physical science and supercomputers, as well as in existing graphics applications. A GPU is also a multi-threaded processor system designed to execute the same program code and manage together threads having the same properties that are collected into a thread group.

Multi-thread processing is suitable for a multi-core system with a high degree of integration.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, there is provided a multi-thread processing method including scheduling, at a processor, one of a plurality of thread groups allocated by a job distributor, determining whether the thread group has been initialized based on an examination an uninitialized flag of the scheduled thread group, generating a thread group descriptor for the scheduled thread group and initializing the thread group based on the determination of whether the thread group has been initialized, and initializing a thread descriptor based on a determination of whether initialization is needed and sequentially executing each thread in the scheduled thread group.

The scheduling of the thread group may include determining a priority of the plurality of thread groups, and scheduling a thread group having a high priority.

The scheduling of the thread group may include receiving a request for allocation of a thread group from the job distributor, detecting the number of threads that can be allocated to a thread descriptor memory based on an occupation counter configured to hold a number of slots currently being used in the thread descriptor memory, determining whether the thread group can be allocated based on the detected number of threads, and allocating the thread group to an empty slot among the slots of the thread descriptor memory based on an occupation vector configured to indicate whether the slots is empty.

The executing of the thread may include reading an instruction pointer from the thread group descriptor, forwarding the instruction pointer to an instruction memory for transmitting an instruction starting at the pointer to a processing unit, and sequentially issuing each thread in the scheduled thread group to the processing unit and executing the thread according to an instruction.

The executing of the thread may include sequentially initialized the threads and transmitting the threads to the processing unit for execution, and wherein a single port memory is used as a thread descriptor memory.

The initializing of the thread group may include setting the uninitialized flag so as to indicate that the thread group has been initialized, and decrementing an occupation counter by the number of thread descriptors required by the thread group, wherein the occupation counter is configured to hold the number of slots currently being used in a thread descriptor memory.

The thread group descriptor may include a root thread group descriptor configured to contain information shared by branch thread groups that are created by splitting the scheduled thread group during execution of the scheduled thread group, and a branch thread group descriptor configured to contain information about each of the branch thread groups.

The root thread group descriptor may include the uninitialized flag indicating whether the scheduled thread group has been initialized and a thread vector representing a location of a slot of the root thread group among slots of a thread descriptor memory.

In response to the thread group not been initialized, the initializing of the thread descriptor and the executing of the thread may include detecting an empty slot among the slots of the thread descriptor memory, setting a bit corresponding to the detected empty slot in an occupation vector and the thread vector indicating that the empty slot is being used in the scheduled thread group, initializing a thread descriptor of an unprocessed thread in the thread group and issuing the thread to a processing unit, and executing the thread in the processing unit and returning the result of execution, wherein in response to an unprocessed thread being present in the thread group, repeating the detecting of the empty slot, the setting of the bit, the initializing of the thread descriptor, the executing of the thread, and the returning of the result of the execution for the unprocessed thread, and wherein in response to all threads in the thread group being processed, setting the uninitialized flag to indicate that the thread group has been initialized and waiting for another thread group to be scheduled.

In response to the thread group already being initialized, the initializing of the thread descriptor and the executing of the thread may include issuing an unprocessed thread in the thread group to the processing unit, executing the issued thread in the processing unit, and returning the result of execution, in response to an unprocessed thread being present in the thread group, repeating the issuing of the unprocessed threads, the executing of the issued thread and the returning of the result of the execution, and in response to all the threads in the thread group being processed, waiting for another thread group to be scheduled.

In another general aspect, there is provided a multi-thread processing apparatus including a processing unit configured to process threads received from a thread issuer, and a thread scheduler including a thread group selector configured to select one thread group from among a plurality of thread groups allocated by a job distributor and to schedule the selected thread group, a thread group initializer configured: to determine whether the thread group has been initialized based on examination of an uninitialized flag of the scheduled thread group, to generate a thread group descriptor for the scheduled thread group and to initialize the scheduled thread group based on the determination of whether the scheduled thread group has been initialized, and to initialize a thread descriptor based on the determination of whether the scheduled thread group has been initialized, the thread issuer configured to sequentially issues threads of the scheduled thread group, a thread group descriptor memory configured to store information related to the thread group, and a thread descriptor memory configured to store information related to the threads.

The thread group selector may be further configured to determine the priority of the plurality of thread groups and to schedule a thread group having a high priority.

The apparatus of claim 12, wherein the thread group selector may be further configured to: receive a request for allocation of a thread group from the job distributor, detect the number of threads that can additionally be allocated to the thread descriptor memory from an occupation counter, which is configured to hold the number of slots currently being used in the thread descriptor memory, determine whether the thread group can be allocated, and allocate the thread group to an empty slot among the slots of the thread descriptor memory based on an occupation vector that represents whether each of the slots is empty.

The apparatus may include an instruction memory configured to receive an instruction pointer from the thread scheduler and to transmit an instruction starting at the pointer to the processing unit, wherein the thread scheduler is configured to read the instruction pointer from the thread group descriptor, and wherein the processing unit is configured to sequentially receive the threads in the scheduled thread group from the thread issuer and to execute the threads based on the instruction.

The thread descriptor memory may use a single port memory.

The thread group initializer may be configured to set the uninitialized flag to indicate that the thread group has been initialized and to decrement an occupation counter by the number of thread descriptors required by the thread group, and wherein the occupation counter holds the number of slots currently being used in the thread descriptor memory.

The thread group descriptor may include a root thread group descriptor containing information shared by branch thread groups that are created by splitting the scheduled thread group during execution of the scheduled thread group and a branch thread group descriptor containing information about each of the branch thread groups.

The root thread group descriptor comprises the uninitialized flag representing whether the scheduled thread group has been initialized and a thread vector representing a location of a slot of the thread descriptor memory that is allocated to the root thread group.

In another general aspect, there is provided a multi-thread processing apparatus including: a thread group selector configured to select one thread group from among a plurality of thread groups allocated by a job distributor and to schedule the selected thread group, a thread group initializer configured to generate a thread group descriptor for the scheduled thread group and to initialize the scheduled thread group, wherein the thread group initializer including: an initialization information storage configured to store initialization information related to the scheduled thread group, and a thread information generator configured to sequentially initialized threads of the scheduled thread group and to sequentially transmit the initialized thread to the thread issuer, wherein the initialization information may compromise at least one of a size of the thread group, an instruction pointer, or a state memory pointer, a thread issuer configured to sequentially issues threads of the scheduled thread group to a processing unit, an instruction memory configured to receive an instruction pointer and to transmit an instruction starting at the pointer to the processing unit, a thread group descriptor memory configured to store information related to the thread group, and a thread descriptor memory configured to store information related to the threads and to use a single port memory.

Other features and aspects will be apparent from the following detailed description, the drawings, and the claims.

### BRIEF DESCRIPTION OF THE DRAWINGS

FIG. 1 is a diagram illustrating an example of a multi-thread processing method for sequentially processing threads.

FIG. 2 is a diagram illustrating an example of a procedure of multi-thread processing for sequentially processing threads.

FIG. 3 is a diagram illustrating an example of a process of allocating and initializing a thread group.

FIG. 4 is a diagram illustrating an example of a process of initializing a thread group and executing threads.

FIG. 5 is a diagram illustrating an example of a system employing a multi-thread processing method.

FIG. 6 is a diagram illustrating an example of a thread scheduler.

FIG. 7 is a diagram for explaining an example of a initialization process employing a multi-thread processing method for sequentially processing threads.

FIG. 8 is a diagram illustrating an example of a of a thread group manager.

FIG. 9 is a diagram illustrating an example of a processing unit.

FIG. 10 is a diagram diagram illustrating an example of a multi-thread processing apparatus for sequentially processing threads.

Throughout the drawings and the detailed description, unless otherwise described, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the systems, apparatuses and/or methods described herein will be apparent to one of ordinary skill in the art. The progression of processing steps and/or operations described is an example; however, the sequence of and/or operations is not limited to that set forth herein and may be changed as is known in the art, with the exception of steps and/or operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

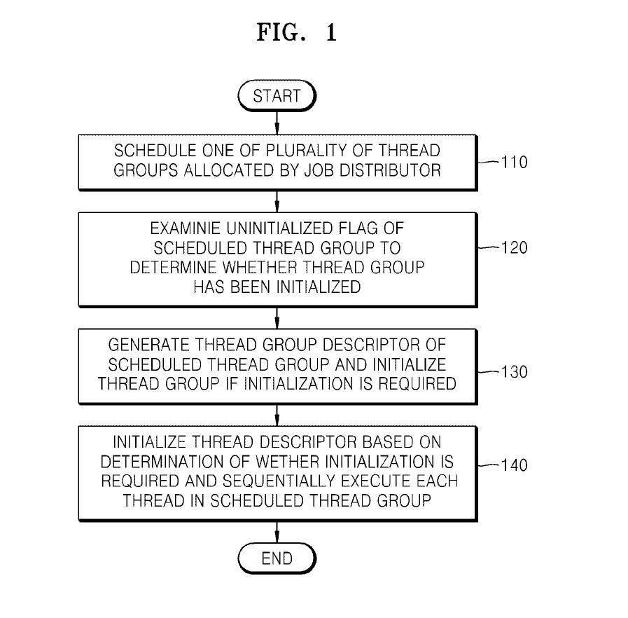

FIG. 1 is a diagram illustrating an example of a multi-thread processing method for sequentially processing threads. The operations in FIG. 1 may be performed in the sequence and manner as shown, although the order of some operations may be changed or some of the operations omitted without departing from the spirit and scope of the illustrative examples described. Many of the operations shown in FIG. 1 may be performed in parallel or concurrently. Referring to FIG. 1, in operation 110, a processing apparatus schedules one of a plurality of thread groups allocated by a job distributor. The job distributor may receive jobs such as data, program codes, and instructions to be processed from the outside and the job distributor may allocate the jobs to the processing apparatus. Jobs to be executed may be allocated to a processing unit set in the form of thread groups. The processing unit set is a plurality of processing units, and the processing apparatus may include a plurality of processing unit sets. The thread groups being allocated may be independent of one another so that execution of one thread group does not affect execution of another thread group.

The processing apparatus may determine the priority of a plurality of thread groups and schedule a thread group having a high priority based on the determination.

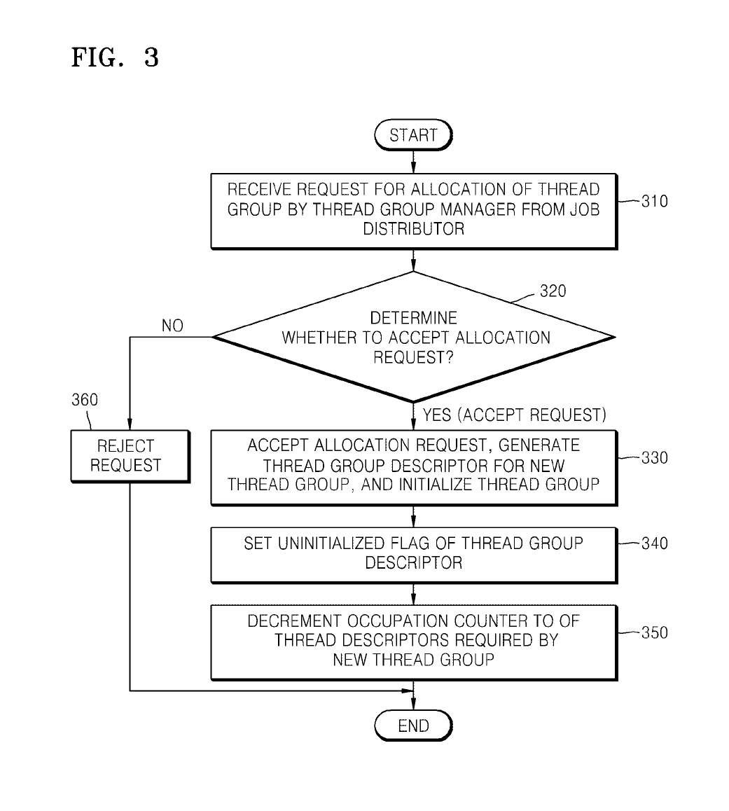

Upon receipt of a request to allocate a thread groups from the job distributor, the processing apparatus may determine the number of additional threads that can be allocated to a thread descriptor memory and may determine whether a thread group can be allocated, as described in more detail with reference to FIG. 3.

In operation, 120, the processing apparatus examines an uninitialized flag of the scheduled thread group to determine whether the thread group has been initialized. The uninitialized flag may indicate whether initialization has been performed on the scheduled thread group.

In operation, 130, the processing apparatus creates a thread group descriptor for the scheduled thread group and initializes the thread group, based on the result of determination of the initialization. If the thread group has not been initialized, the processing apparatus creates a thread group descriptor for the thread group and initializes the thread group. When initializing the thread group, the processing apparatus may set an uninitialized flag to indicate that the thread group has been initialized and decrement an occupation counter by the number of thread descriptors needed by the thread group. The occupation counter holds the number of slots currently being used in a thread descriptor memory. If the thread group has already been initialized, the processing apparatus execute threads in the thread group without performing initialization of the threads.

A thread group descriptor may include a root thread group descriptor, which contains information shared by thread groups that are created by splitting the scheduled thread group during execution of the scheduled thread group, and a branch thread group descriptor, which contains independent information about each of the branch thread groups. The root thread group descriptor may include an uninitialized flag representing whether the scheduled thread group has been initialized and a thread vector representing a location of a slot that is allocated to the root thread group among slots of the thread descriptor memory.

In operation 140, the processing apparatus initializes a thread descriptor based on the determination of whether initialization is needed and sequentially executes each thread in the scheduled thread group. If the thread group has already been initialized, the processing apparatus executes threads in the thread group without performing initialization of the threads. If the thread group has not yet been initialized, the processing apparatus sequentially initializes each thread in the thread group and transmits the result to a processing unit. Thus, the processing apparatus may hide latency incurred due to initialization of a thread while the processing unit executes the thread. Since the threads are sequentially initialized and transmitted to the processing unit, a single port memory may be used as a thread descriptor memory.

The processing apparatus may read an instruction pointer from a thread group descriptor and forward the instruction pointer to an instruction memory to transmit an instruction starting at the instruction pointer to a processing unit. The processing apparatus may also issue threads in the scheduled thread group sequentially to the processing unit and execute each thread according to the instruction.

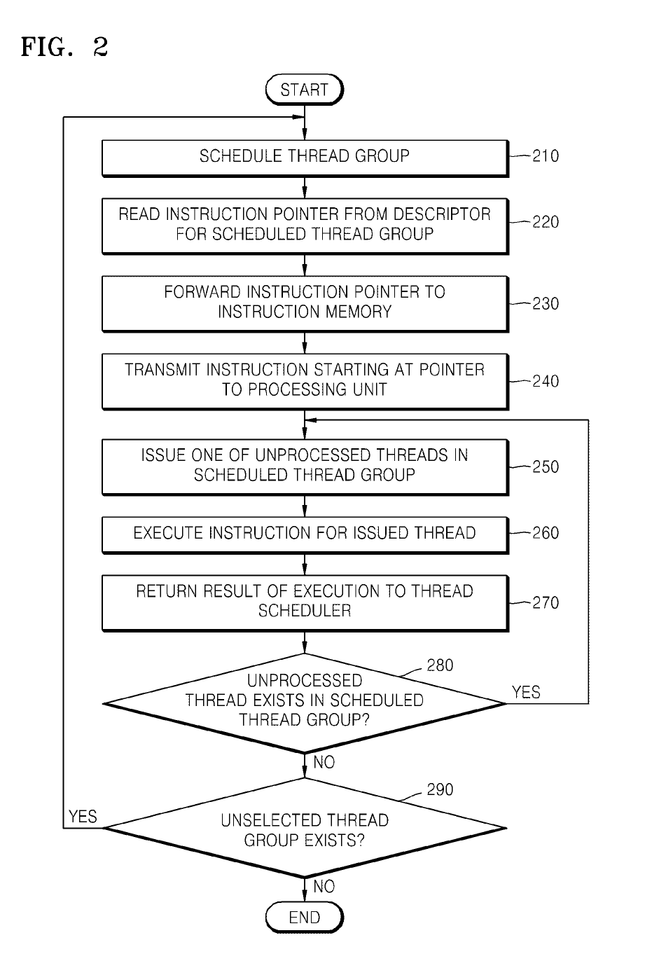

FIG. 2 is a diagram illustrating an example of a procedure of multi-thread processing for sequentially processing threads. The operations in FIG. 2 may be performed in the sequence and manner as shown, although the order of some operations may be changed or some of the operations omitted without departing from the spirit and scope of the illustrative examples described. Many of the operations shown in FIG. 2 may be performed in parallel or concurrently. In operation 210, a processing apparatus schedules one of a plurality of thread groups allocated by a job distributor. The thread groups to be allocated may be independent of one other so that execution of one thread group does not affect execution of another thread group. The processing apparatus may determine the priority of a plurality of thread groups and schedule a thread group having a high priority based on the result of determination.

In operation 220, the processing apparatus reads an instruction pointer from a descriptor for the scheduled thread group. In operation 230, the processing apparatus forwards an instruction pointer to an instruction memory.

In operation 240, the processing apparatus transmits an instruction beginning with the instruction pointer to a processing unit. A single instruction or a plurality of instructions may be transmitted to the processing unit.

In operation 250, the processing apparatus issues one of unprocessed threads in the scheduled thread group to the processing unit.

In operation 260, the processing apparatus executes an instruction for the issued thread.

In operation 270, the processing apparatus returns the result of execution to a thread scheduler.

In operation 280, the processing apparatus determines whether an unprocessed thread is present in the scheduled thread group.

If unprocessed threads are present in the scheduled thread group, Operations 250 through 270 are repeatedly on one of the unprocessed threads.

If unprocessed threads are not present in the scheduled thread group, in operation 290, the processing apparatus determines whether an unscheduled thread group exists among the allocated thread groups.

If the unscheduled thread group exists, Operations 210 through 280 are repeated. If the unscheduled thread group does not exist, the procedure is terminated.

FIG. 3 is a diagram illustrating an example of a process of allocating and initializing a thread group. The operations in FIG. 3 may be performed in the sequence and manner as shown, although the order of some operations may be changed or some of the operations omitted without departing from the spirit and scope of the illustrative examples described. Many of the operations shown in FIG. 3 may be performed in parallel or concurrently.

In operation 310, a thread group manager of a processing apparatus receives a request to allocate a thread group (hereinafter, referred to as an “allocation request”) from a job distributor. The job distributor receives jobs such as data, program codes, and instructions to be processed from the outside and allocates the jobs to the processing apparatus. The jobs to be processed may be assigned to a processing unit set in the form of thread groups. The processing unit set is a set of a plurality of processing units, and the processing apparatus may include a plurality of processing unit sets. The thread groups being allocated may be independent of one another so that execution of one thread group does not affect execution of another thread group. The allocation request may contain information about a size of the thread group to be allocated.

In operation 320, the processing apparatus determines whether to accept the allocation request. The processing apparatus may determine whether to accept the allocation request depending on whether resource is available in a thread group descriptor memory and a thread descriptor memory. In a non-exhaustive example, the processing apparatus may determine whether to accept the allocation request depending on whether there is an empty slot in a thread descriptor memory. If no empty slot is present in the thread descriptor memory, in operation 360, the processing apparatus rejects the allocation request.

If an empty slot is present in the thread descriptor memory, operation 330 is performed. The processing apparatus accepts the allocation request, generates a thread group descriptor for a new thread group, and initializes the new thread group. The initialization of thread descriptors is not yet performed.

In operation 340, the processing apparatus sets an uninitialized flag of the thread group descriptor.

The processing apparatus may set an uninitialized flag of a root thread group descriptor to indicate that the thread group has been initialized.

In operation 350, the processing apparatus decrements an occupation counter by the number of thread descriptors needed by the new thread group. In the allocation of a thread group, initialization of thread descriptors for threads in a thread group is skipped, and only a thread group descriptor is initialized. In the allocation of a thread group, a particular thread descriptor slot is not yet determined for allocation to a thread group or initialization. Thus, it is possible to minimize degradation in the performance of hardware for initializing a thread group and a memory for storing information about a thread group, thus achieving a design using a small amount of resources.

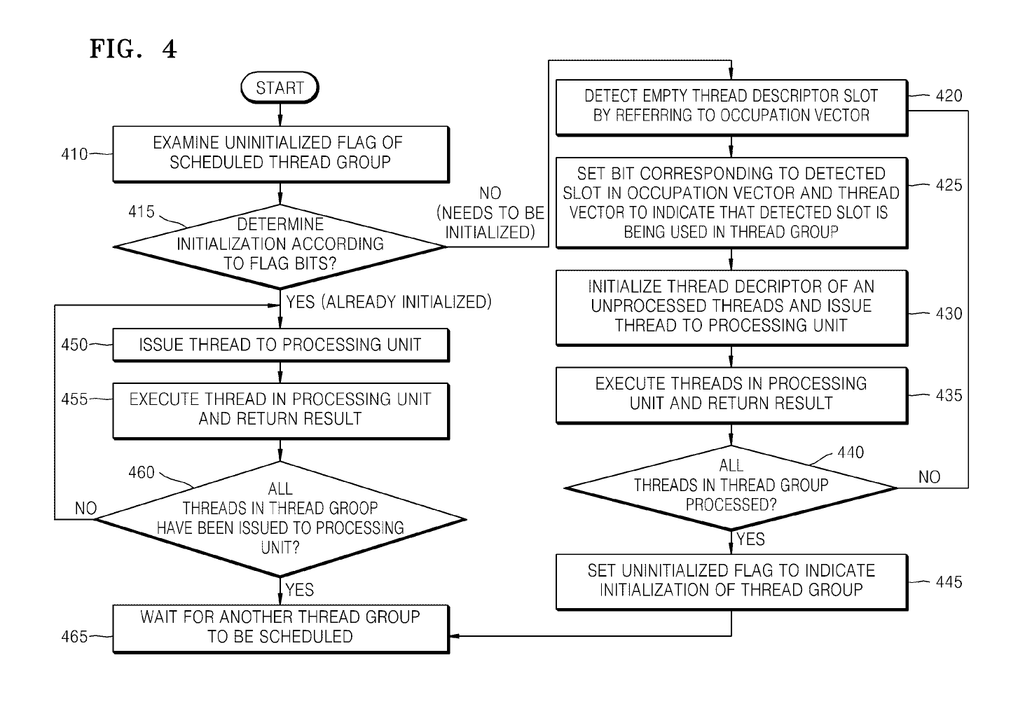

FIG. 4 is a diagram illustrating an example of a process of initializing a thread group and executing threads. The operations in FIG. 4 may be performed in the sequence and manner as shown, although the order of some operations may be changed or some of the operations omitted without departing from the spirit and scope of the illustrative examples described. Many of the operations shown in FIG. 4 may be performed in parallel or concurrently.

In operation 410, a processing apparatus examines an uninitialized flag of a scheduled thread group.

In operation 415, the processing apparatus determines whether the scheduled thread group has been initialized according to bits of the uninitialized flag.

If the scheduled thread group is not yet initialized, i.e., requires initialization, in operation 420, the processing apparatus detects an empty thread descriptor slot by referring to an occupation vector. If the scheduled thread has already been initialized, i.e., does not require initialization, operation 450 is performed.

In operation 425, the processing apparatus sets a bit corresponding to the detected empty thread descriptor slot in an occupation vector and a thread vector in order to indicate that the empty thread descriptor slot is being used in the scheduled thread group.

In operation 430, the processing apparatus initializes a thread descriptor of one of unprocessed threads and issues the thread to a processing unit.

In operation 435, a processing unit in the processing apparatus executes a thread, and the processing apparatus returns the result of execution to a thread scheduler.

In operation 440, the processing apparatus determines whether all threads in the scheduled thread group have been processed.

If an unprocessed thread is present in the scheduled thread group, the processing apparatus returns to operation 420 to perform operations 420 through 435.

The processing apparatus may use a deferred initialization technique whereby thread descriptors for threads in the scheduled thread group are not initialized at the same time but sequentially during distribution of each of the threads. Thus, the processing apparatus may hide latency incurred due to initialization of a thread while the processing unit executes the thread.

If all the threads in the scheduled thread group have been processed, in operation 445, the processing apparatus sets the uninitialized flag so as to indicate that the thread group has been initialized. In operation 465, the processing apparatus waits for another thread group to be scheduled.

In operation 450, the process returns to operation 415, and if the scheduled thread group has already been initialized, i.e., does not require initialization, the processing apparatus issues a thread to the processing unit.

In operation 455, the processing unit in the processing apparatus executes a thread, and the processing apparatus returns the result of execution to the thread scheduler.

In operation 460, the processing apparatus determines whether all threads in the scheduled thread group have been processed.

If an unprocessed thread is present in the scheduled thread group, the processing apparatus returns to operation 450 in order to perform operations 420 through 435.

If all the threads in the scheduled thread group have been processed, in operation 465, the processing apparatus waits for another thread group to be scheduled.

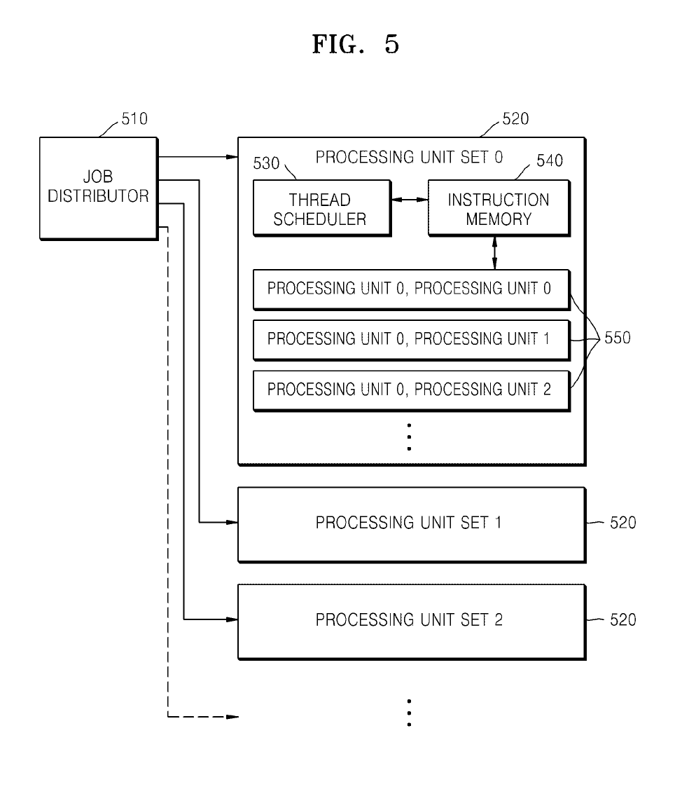

FIG. 5 is a diagram illustrating an example of a system employing a multi-thread processing method. Referring to FIG. 5, the system employing a multi-thread processing method includes a job distributor 510 and at least one processing unit set 520.

The job distributor 510 may receive jobs such as data, program codes, and instructions to be processed from the outside and allocate the jobs to a processing apparatus. Jobs to be executed may be allocated to the at least one processing unit set 520 in the form of thread groups. The processing unit set 520 is a set of a plurality of processing units 550, and the processing apparatus may include a plurality of processing unit sets 520.

As illustrated in FIG. 5, each of the processing unit sets 520 may include a thread scheduler 530, an instruction memory 540, and a plurality of processing unit 550. The configuration of components illustrated in FIG. 5 is a non-exhaustive illustration, and other arrangements of components are considered to be well within the scope of the present disclosure. For example, the processing unit set 520 may be realized with fewer or more components than those illustrated in FIG. 5.

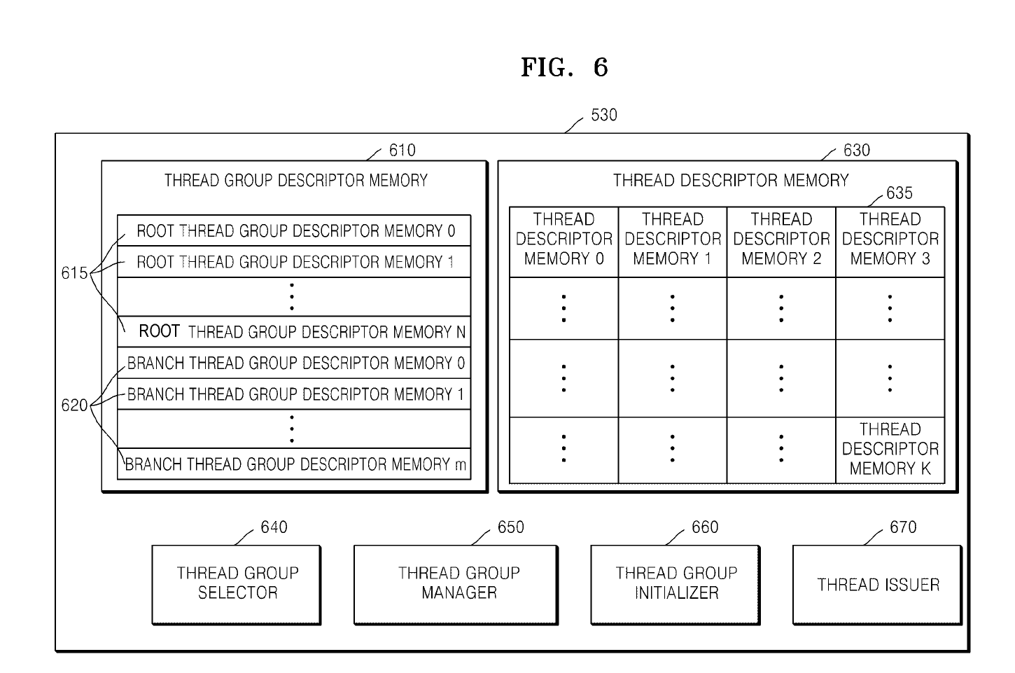

The thread scheduler 530 may store information about jobs allocated by the job distributor 510, such as thread groups, and distribute the allocated jobs so that the processing units 550 execute the jobs. One thread scheduler 530 may manage the plurality of processing units 550. The thread scheduler 530 may include a thread group descriptor memory, a thread descriptor memory, a thread group selector, a thread group manager, a thread group initializer, and a thread issuer, as described in below with reference to FIG. 6.

The instruction memory 540 may store instructions to be executed for threads in a thread group assigned to the thread scheduler 530.

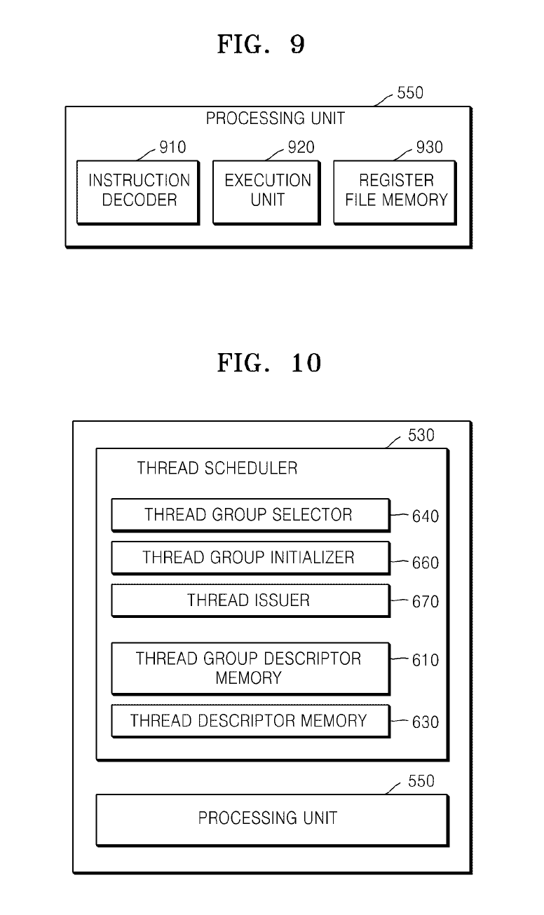

The processing unit 550 receives information about threads from the thread scheduler 530 and an instruction to be executed for each of the threads from the instruction memory 540 and executes the thread based on the information and the instruction. The processing unit 550 may include an instruction decoder, an execution unit, and a register file memory, as described in below with reference to FIG. 9.

FIG. 6 is a diagram illustrating an example of the thread scheduler 530 in FIG. 5.

Referring to FIG. 6, the thread scheduler 530 may include a thread group descriptor memory 610, a thread descriptor memory 630, a thread group selector 640, a thread group manager 650, a thread group initializer 660, and a thread issuer 670. The configuration of components illustrated in FIG. 6 is a non-exhaustive illustration, and other arrangements of components are considered to be well within the scope of the present disclosure. For example, the thread scheduler 530 may be realized by fewer or more components than those illustrated in FIG. 6.

The thread group descriptor memory 610 may store information about thread groups. The thread group descriptor memory 610 may store information shared by threads in a thread group, such as an instruction pointer.

A thread group descriptor may include root thread group descriptors 615 and branch thread group descriptors 620. A thread group may be repeatedly split into multiple thread groups and merged with another thread group while executing instructions. The root thread group descriptors 615 refer to information shared by all branch thread groups into which a root thread group, which is a initially allocated thread group, is split. The branch thread group descriptors 620 denotes independent information about each of the branch thread groups.

The root thread group descriptor 615 may include various pieces of information about a thread group such as an uninitialized flag and a thread vector. The uninitialized flag may be used to indicate whether the thread group has been initialized when it is first allocated. The thread vector may represent a location of a slot that is allocated to the root thread group among slots of the thread descriptor memory 630. For example, the thread vector may indicate the location of the slot by using one-hot encoding.

The root thread group descriptor 615 may further include information about a processing unit to which a thread group is allocated and a register file base address, a register file size and state information associated with the thread group.

The branch thread group descriptor 620 may include information that is needed independently by each of the branch thread groups that are generated by splitting the root thread group. A first thread descriptor (TD) pointer indicates a location of a slot on a thread group memory, which corresponds to a thread descriptor of a first thread in the branch thread group. The branch thread group descriptor 620 may store only a pointer of a first thread in the branch thread group instead of information about all the threads. Thus, the memory required may be reduced.

The branch thread group descriptor 620 may further include an ID of a root thread group to which a branch thread group belongs, the number of threads in the branch thread group, information about a state of a thread group, and flow control information.

The thread descriptor memory 630 may store information about each thread. A thread descriptor 635 may include information needed for defining each thread and may be stored in the thread descriptor memory 630.

The thread descriptor 635 may include information that is independently needed for each thread. If a first TD pointer of the branch thread group descriptor 620 points to a particular thread, the thread may then point to a pointer associated with a next thread in a branch thread group by using information about a next TD pointer. In this way, a thread group may manage its threads by using a linked-list method.

The thread descriptor 635 may further include information such as a thread ID, a register file offset, and state information.

The thread group selector 640 may select one thread group from among a plurality of thread groups allocated by the job distributor 510 and schedule the selected thread group.

The thread group selector 640 may determine the priority of a plurality of thread groups and schedule a thread group with a high priority based on the determination.

The thread group manager 650 may mange operations such as allocation of a thread group, distribution of threads, and splitting, merging, and invalidation of thread groups.

The thread group initializer 660 may perform an initialization process on thread groups. The thread group initializer 660 may only store basic information needed for initialization without performing initialization on the thread group when a thread group is initially allocated by the job distributor 510. The thread group initializer 660 may initialize and issue threads in the thread group one by one for issuance when distributing the threads. The thread group initializer 660 may sequentially repeat these operations. The information needed for initialization may include a size of a thread group, an instruction pointer, and a state memory pointer. The thread group initializer 660 may be configured to sequentially initialize each of the threads for issuance, enabling initialization only with a single thread information generator. Thus, it is possible to design the thread descriptor memory 630 with a single port memory.

The thread issuer 670 issues threads in a thread group selected by the threads group selector 640 to the processing unit 550 one by one and receives the result of processing of the threads.

Each thread scheduler 530 may manage the plurality of processing units 550. Thus, the thread scheduler 530 may manage the thread group descriptor memory 610 and the thread descriptor memory 630 for each of the processing units 550.

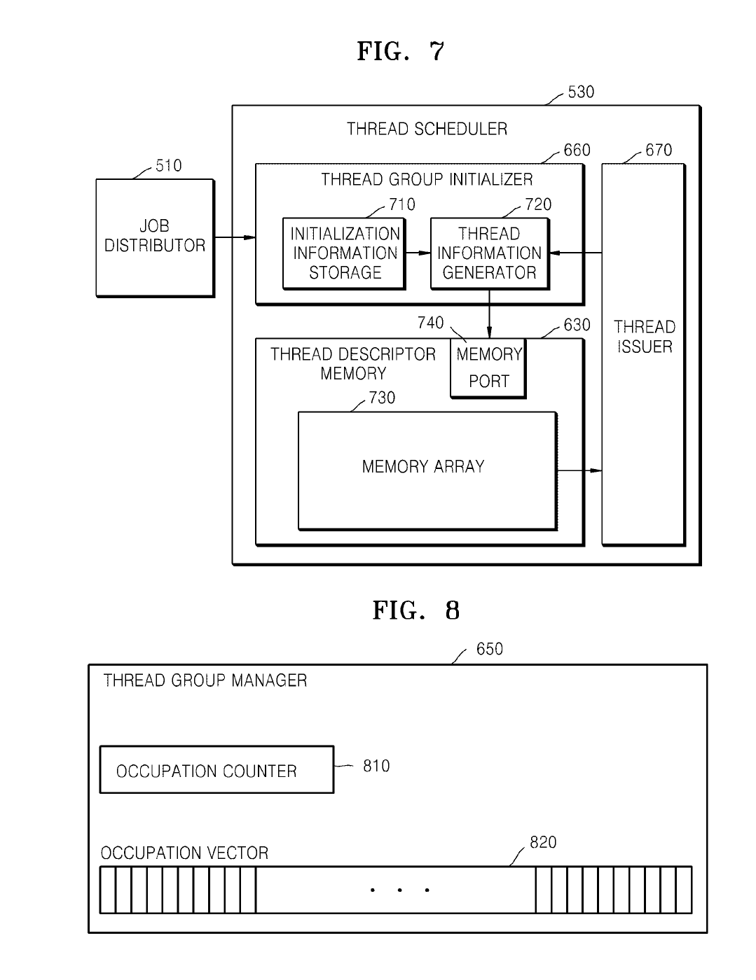

FIG. 7 is a diagram illustrating an example for explaining an initialization process employing a multi-thread processing method of sequentially processing threads. Referring to FIG. 7, a thread group initializer 660 may include an initialization information storage 710 and a thread information generator 720.

A thread scheduler 530 may schedule a thread group allocated by a job distributor 510 and store initialization information related to the scheduled thread group in the initialization information storage 710. For example, the initialization information storage 710 may hold information such as a size of the thread group, an instruction pointer, and a state memory pointer.

During distribution of threads, the threads are sequentially initialized one by one by using the thread information generator 720 and transmitted to the thread issuer 670. Thus, the multi-thread processing apparatus may require a single thread information generator 720 and a single memory port 740.

A conventional multi-thread processing apparatus uses a plurality of thread information generators to generate initialization information in parallel for each thread in a thread group, and writes data to a thread descriptor memory in parallel. Thus, the conventional multi-thread processing apparatus requires a plurality of thread information generators and a plurality of memory ports, thus causing hardware overhead. Furthermore, the conventional multi-thread processing apparatus requires long processing time even when using a single port.

A multi-thread processing apparatus described herein may employ a deferred initialization technique to sequentially initialize and issue threads one by one, thereby allowing initialization only with a single thread information generator. Thus, it is possible to design a thread descriptor memory with a single port memory. The multi-thread processing apparatus may be designed to sequentially execute threads in a thread group, thus allowing efficient storage and management of the thread group. The multi-thread processing apparatus may also use a single port memory instead of a multi-port memory to reduce the area and power consumption needed to achieve the same performance.

FIG. 8 is a diagram illustrating an example of the thread group manager 650 in FIG. 6.

Referring to FIG. 8, the thread group manager 650 may include an occupation counter 810 and an occupation vector 820. The configuration of components illustrated in FIG. 8 is a non-exhaustive illustration, and other arrangements of components are considered to be well within the scope of the present disclosure. For example, the thread group manager 650 may be realized by fewer or more components than those illustrated in FIG. 8.

The occupation counter 810 may hold the number of thread descriptor slots currently being used in the thread descriptor memory 630. The occupation counter 810 may be used to detect the number of threads that can additionally be allocated to the thread descriptor memory 630. The occupation counter 810 may also be used to determine whether a new thread group can be allocated to a corresponding processing unit.

The occupation vector 820 may represent whether each of the thread descriptor slots of the thread descriptor memory 630 is currently being occupied in thread groups, i.e., whether each thread descriptor slot is empty. The occupation vector 820 may indicate whether the thread descriptor slot is empty by using one-hot encoding. The thread group manager 650 searches for an empty thread descriptor slot by using the occupation vector 820 and allocate a found empty thread descriptor slot to a new thread group.

FIG. 9 is a diagram illustrating an example of the processing unit 550 in FIG. 5.

Referring to FIG. 9 the processing unit 550 may include an instruction decoder 910, an execution unit 920, and a register file memory 930. The configuration of components illustrated in FIG. 9 is a non-exhaustive illustration, and other arrangements of components are considered to be well within the scope of the present disclosure. For example, the processing unit 550 may be realized by fewer or more components than those illustrated in FIG. 9.

The instruction decoder 910 may convert instructions received from the instruction memory 540 into a format that the execution unit 920 can process and transmit the result to the execution unit 920.

The execution unit 920 is a device for performing actual operations and may include various operation units such as an arithmetic unit, a floating point unit, a trigonometric function unit, and a memory load/store unit.

The register file memory 930 may transmit an input operand to the execution unit 920 and receive the result of execution from the execution unit 920. Since each thread has a register file set, the register file memory 930 may be split into regions, one of which is allocated to each thread. Each thread may access a register based on a register number and an offset address assigned to the thread.

FIG. 10 is a diagram illustrating an example of a multi-thread processing apparatus for sequentially processing threads. Referring to FIG. 10, the multi-thread processing apparatus according to the present embodiment may include a thread scheduler 530 and a processing unit 550.

The thread scheduler 530 may store information about jobs allocated by the job distributor 510, such as thread groups, and distribute the allocated jobs so that the processing unit 550 executes the jobs.

The thread scheduler 530 may include a thread group descriptor memory 610, a thread descriptor memory 630, a thread group selector 640, a thread group initializer 660, and a thread issuer 670. The configuration of components illustrated in FIG. 10 is a non-exhaustive illustration, and other arrangements of components are considered to be well within the scope of the present disclosure. For example, the thread scheduler 530 may be realized by fewer or more components than those illustrated in FIG. 10.

The thread group descriptor memory 610 may store information about thread groups.

The thread group descriptor memory 610 may store information shared by threads in a thread group, such as an instruction pointer.

As shown in FIG. 6, a thread group descriptor memory 610 may include root thread group descriptors 615 and branch thread group descriptors 620. A thread group is repeatedly split into multiple thread groups and merged with another thread group while executing instructions. The root thread group descriptors refer to information shared by all branch thread groups into which a root thread group, which is an initially allocated thread group, is split. The branch thread group descriptors mean independent information about each of the branch thread groups.

The thread descriptor memory 630 may store information about each thread. A thread descriptor 635 may include information needed for defining each thread and may be stored in the thread descriptor memory 630.

The thread group selector 640 may select one thread group from among a plurality of thread groups allocated by the job distributor 510 and schedule the selected thread group. The thread group selector 640 may determine the priority of a plurality of thread groups and schedule a thread group with a high priority based on the result of determination.

The thread group initializer 660 may perform an initialization process on thread groups. The thread group initializer 660 may be configured to sequentially initialize each of the threads for issuance, thus enabling initialization only with a single thread information generator. Thus, it is possible to design the thread descriptor memory 630 with a single port memory.

The thread issuer 670 issues threads in a thread group selected by the threads group selector 640 to the processing unit 550 one by one and receives the result of processing of the threads.

The processing unit 550 receives information about threads from the thread scheduler 530 and an instruction that is to be executed for each of the threads from the instruction memory 540. The processing unit 550 executes the thread based on the information and the instruction.

The processing unit 550 may include the instruction decoder (910 in FIG. 9), the execution unit (920 in FIG. 9), and the register file memory (930 in FIG. 9). The configuration of components illustrated in processing unit 550 is a non-exhaustive illustration, and other arrangements of components are considered to be well within the scope of the present disclosure. The processing unit 550 may be realized by fewer or more components than the instruction decoder 910, the execution unit 920, and the register file memory 930.

The instruction decoder 910 may convert instructions received from the instruction memory 540 into a format that the execution unit 920 can process and transmit the result to the execution unit 920. The execution unit 920 is a device for performing actual operations and may include various operation units such as an arithmetic unit, a floating point unit, a trigonometric function unit, and a memory load/store unit.

The register file memory 930 may transmit an input operand to the execution unit 920 and receive the result of execution from the execution unit 920. Since each thread has a register file set, the register file memory 930 may be split into regions, one of which is allocated to each thread. Each thread may access a register based on a register number and an offset address assigned to the thread.

The processes, functions, and methods described above can be written as a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device that is capable of providing instructions or data to or being interpreted by the processing device. The software also may be distributed over network coupled computer systems so that the software is stored and executed in a distributed fashion. In particular, the software and data may be stored by one or more non-transitory computer readable recording mediums. The non-transitory computer readable recording medium may include any data storage device that can store data that can be thereafter read by a computer system or processing device. Examples of the non-transitory computer readable recording medium include read-only memory (ROM), random-access memory (RAM), Compact Disc Read-only Memory (CD-ROMs), magnetic tapes, USBs, floppy disks, hard disks, optical recording media (e.g., CD-ROMs, or DVDs), and PC interfaces (e.g., PCI, PCI-express, WiFi, etc.). In addition, functional programs, codes, and code segments for accomplishing the example disclosed herein can be construed by programmers skilled in the art based on the flow diagrams and block diagrams of the figures and their corresponding descriptions as provided herein.

The apparatuses and units described herein may be implemented using hardware components. The hardware components may include, for example, controllers, sensors, processors, generators, drivers, and other equivalent electronic components. The hardware components may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The hardware components may run an operating system (OS) and one or more software applications that run on the OS. The hardware components also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a hardware component may include multiple processors or a processor and a controller. In addition, different processing configurations are possible, such a parallel processors.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A multi-thread processing method comprising:
scheduling, at a processor, one of a plurality of thread groups allocated by a job distributor;
determining whether the thread group has been initialized based on an examination an uninitialized flag of the scheduled thread group;
generating a thread group descriptor for the scheduled thread group and initializing the thread group based on the determination of whether the thread group has been initialized; and
initializing a thread descriptor based on a determination of whether initialization is needed and sequentially executing each thread in the scheduled thread group.

2. The method of claim 1, wherein the scheduling of the thread group comprises:
determining a priority of the plurality of thread groups; and
scheduling a thread group having a high priority.

3. The method of claim 1, wherein the scheduling of the thread group comprises:
receiving a request for allocation of a thread group from the job distributor;
detecting the number of threads that can be allocated to a thread descriptor memory based on an occupation counter configured to hold a number of slots currently being used in the thread descriptor memory;
determining whether the thread group can be allocated based on the detected number of threads; and
allocating the thread group to an empty slot among the slots of the thread descriptor memory based on an occupation vector configured to indicate whether the slots is empty.

4. The method of claim 1, wherein the executing of the thread comprises:
reading an instruction pointer from the thread group descriptor;
forwarding the instruction pointer to an instruction memory for transmitting an instruction starting at the pointer to a processing unit; and
sequentially issuing each thread in the scheduled thread group to the processing unit and executing the thread according to an instruction.

5. The method of claim 1, wherein the executing of the thread comprises sequentially initialized the threads and transmitting the threads to the processing unit for execution, and wherein a single port memory is used as a thread descriptor memory.

6. The method of claim 1, wherein the initializing of the thread group comprises:
setting the uninitialized flag so as to indicate that the thread group has been initialized; and
decrementing an occupation counter by the number of thread descriptors required by the thread group,
wherein the occupation counter is configured to hold the number of slots currently being used in a thread descriptor memory.

7. The method of claim 1, wherein the thread group descriptor comprises:
a root thread group descriptor configured to contain information shared by branch thread groups that are created by splitting the scheduled thread group during execution of the scheduled thread group; and
a branch thread group descriptor configured to contain information about each of the branch thread groups.

8. The method of claim 7, wherein the root thread group descriptor comprises the uninitialized flag indicating whether the scheduled thread group has been initialized and a thread vector representing a location of a slot of the root thread group among slots of a thread descriptor memory.

9. The method of claim 8, wherein in response to the thread group not been initialized, the initializing of the thread descriptor and the executing of the thread comprises:
detecting an empty slot among the slots of the thread descriptor memory;
setting a bit corresponding to the detected empty slot in an occupation vector and the thread vector indicating that the empty slot is being used in the scheduled thread group;
initializing a thread descriptor of an unprocessed thread in the thread group and issuing the thread to a processing unit; and
executing the thread in the processing unit and returning the result of execution,
wherein in response to an unprocessed thread being present in the thread group, repeating the detecting of the empty slot, the setting of the bit, the initializing of the thread descriptor, the executing of the thread, and the returning of the result of the execution for the unprocessed thread, and
wherein in response to all threads in the thread group being processed, setting the uninitialized flag to indicate that the thread group has been initialized and waiting for another thread group to be scheduled.

10. The method of claim 8, wherein in response to the thread group already being initialized, the initializing of the thread descriptor and the executing of the thread comprises:
issuing an unprocessed thread in the thread group to the processing unit, executing the issued thread in the processing unit, and returning the result of execution,
in response to an unprocessed thread being present in the thread group, repeating the issuing of the unprocessed threads, the executing of the issued thread and the returning of the result of the execution, and
in response to all the threads in the thread group being processed, waiting for another thread group to be scheduled.

11. A non-transitory computer-readable recording medium having recorded thereon a program for executing the method of claim 1 on a computer.

12. A multi-thread processing apparatus comprising:
a processing unit configured to process threads received from a thread issuer, and
a thread scheduler comprising:
a thread group selector configured to select one thread group from among a plurality of thread groups allocated by a job distributor and to schedule the selected thread group;
a thread group initializer configured:
to determine whether the thread group has been initialized based on examination of an uninitialized flag of the scheduled thread group,
to generate a thread group descriptor for the scheduled thread group and to initialize the scheduled thread group based on the determination of whether the scheduled thread group has been initialized, and
to initialize a thread descriptor based on the determination of whether the scheduled thread group has been initialized;
the thread issuer configured to sequentially issues threads of the scheduled thread group;
a thread group descriptor memory configured to store information related to the thread group; and
a thread descriptor memory configured to store information related to the threads.

13. The apparatus of claim 12, wherein the thread group selector is further configured to determine the priority of the plurality of thread groups and to schedule a thread group having a high priority.

14. The apparatus of claim 12, wherein the thread group selector is further configured to:
receive a request for allocation of a thread group from the job distributor;
detect the number of threads that can additionally be allocated to the thread descriptor memory from an occupation counter, which is configured to hold the number of slots currently being used in the thread descriptor memory;
determine whether the thread group can be allocated; and
allocate the thread group to an empty slot among the slots of the thread descriptor memory based on an occupation vector that represents whether each of the slots is empty.

15. The apparatus of claim 12, further comprising an instruction memory configured to receive an instruction pointer from the thread scheduler and to transmit an instruction starting at the pointer to the processing unit,
wherein the thread scheduler is configured to read the instruction pointer from the thread group descriptor, and
wherein the processing unit is configured to sequentially receive the threads in the scheduled thread group from the thread issuer and to execute the threads based on the instruction.

16. The apparatus of claim 12, wherein the thread descriptor memory uses a single port memory.

17. The apparatus of claim 12, wherein the thread group initializer is configured to set the uninitialized flag to indicate that the thread group has been initialized and to decrement an occupation counter by the number of thread descriptors required by the thread group, and
wherein the occupation counter holds the number of slots currently being used in the thread descriptor memory.

18. The apparatus of claim 12, wherein the thread group descriptor comprises a root thread group descriptor containing information shared by branch thread groups that are created by splitting the scheduled thread group during execution of the scheduled thread group and a branch thread group descriptor containing information about each of the branch thread groups.

19. The apparatus of claim 18, wherein the root thread group descriptor comprises the uninitialized flag representing whether the scheduled thread group has been initialized and a thread vector representing a location of a slot of the thread descriptor memory that is allocated to the root thread group.

20. A multi-thread processing apparatus comprising:
a thread group selector configured to select one thread group from among a plurality of thread groups allocated by a job distributor and to schedule the selected thread group;
a thread group initializer configured to generate a thread group descriptor for the scheduled thread group and to initialize the scheduled thread group, wherein the thread group initializer comprises:
an initialization information storage configured to store initialization information related to the scheduled thread group, and
a thread information generator configured to sequentially initialized threads of the scheduled thread group and to sequentially transmit the initialized thread to the thread issuer,
wherein the initialization information may compromise at least one of a size of the thread group, an instruction pointer, or a state memory pointer;
a thread issuer configured to sequentially issues threads of the scheduled thread group to a processing unit;
an instruction memory configured to receive an instruction pointer and to transmit an instruction starting at the pointer to the processing unit;
a thread group descriptor memory configured to store information related to the thread group; and
a thread descriptor memory configured to store information related to the threads and to use a single port memory.
